(19) United States
(12) Patent Application Publication
(10) Pub. No.: US 2019/0050917 A1
(43) Pub. Date: Feb. 14, 2019

(54) SYSTEM AND METHOD FOR RATING OF ENTERPRISE USING CROWDSOURCING IN COMBINATION WITH WEIGHTED EVALUATOR RATINGS

(71) Applicant: ScoutZinc, LLC, Gainesville, FL (US)

(72) Inventors: DAVID WORTHINGTON HAHN, GAINESVILLE, FL (US); ALEXANDER JEROME WILLIS, GAINESVILLE, FL (US)

(73) Assignee: ScoutZinc, LLC

(21) Appl. No.: 15/950,600

(22) Filed: Apr. 11, 2018

Related U.S. Application Data
(63) Continuation-in-part of application No. 15/676,648, filed on Aug. 14, 2017.

(51) Int. Cl. G06Q 30/02

(52) U.S. Cl. CPC G06Q 30/0282

(57) ABSTRACT

Enterprise evaluation based on crowdsourcing concepts. An approach to enterprise evaluation is described that uses crowd-sourced data and an iterative approach. Individual enterprise evaluators are themselves evaluated and assigned weighting factors based on their acumen and accuracy with regard to enterprise evaluation. Enterprise evaluations are provided by each enterprise evaluator, who collectively form a crowdsourcing crowd, and weighted according to each evaluator's assigned weighting factor. The crowd-sourced weighted-averages from all evaluators are combined and used periodically and iteratively to evaluate the individual crowdsourcing participants and to re-calculate their individual weighting factors. The approach provides more accurate and more directed enterprise evaluations as compared to simple arithmetic averaging of crowd-sourced data, and is improved over time with each iteration.

### CROSS-REFERENCE TO RELATED APPLICATIONS

The present application is a continuation-in-part application of parent application Ser. No. 15/676,648, filed on Aug. 14, 2017 (Attorney docket 15309-001). The parent patent application is incorporated in its entirety herein.

### FIELD OF INVENTION

The present invention relates in general to the field of rating of an enterprise, including the specific use of crowdsourcing concepts, and the general concept of using performance-based weighted-averages of individual evaluators to arrive at an overall rating or set of ratings for the enterprise evaluated, the enterprise referred to as the evaluaee herein.

### BACKGROUND

There is a general need to evaluate an enterprise in a wide range of circumstances, including for example the evaluation of businesses and concerns, both commercial and not-for-profit, that provide products, goods, or services. The term “enterprise” is defined as a commercial or industrial activity or organization, including for-profit or not-for-profit, and the term “concern” as a commercial or corporate business or organization and the people who constitute it, including for-profit or not-for-profits, as related to any products, goods, or services offered. For example, travelers want to evaluate or review evaluations of quality of hotels, transportation services and tourism related services such as guides; while those eating outside the home want to evaluate or review evaluations of quality of food and service at restaurants; those using professional services, which as physicians and lawyers, want to evaluate or review evaluations of the quality of care or advice provided; and those viewing performing arts, notably movies, want to evaluate or review evaluations of such films or performances. These scenarios are common across many areas of enterprise, although many other examples are relevant.

Perhaps the greatest challenge with such enterprise evaluations is accurately covering the broad range of prospects and concerns throughout large geographic areas, such as the United States or across foreign countries as the world becomes more connected and people travel more extensively. It is also critical to consider the rating skills, acumen, and biases of individuals conducting the evaluation (referred to as evaluators herein). Undoubtedly some will be more skilled than others in evaluating quality of services or products, and some may be biased for or against certain concerns in the evaluation pool.

To assist with enterprise evaluation (i.e. product and service evaluation), many consumers and users, utilize what are commonly referred to as “critics” or rely on “rating sites”. Critics generally have expertise and/or reside in specific geographic regions with deep knowledge and relationships, relevant to the enterprise that is being recruited. These critics provide evaluations (i.e., enterprise ratings or recommendations) to those looking to use or patronize such enterprises. There are literally many thousands or tens of thousands to perhaps millions of critics in the United States at all levels and fields of enterprise. A key limitation is that critics are unable to cover all regions and all enterprises and concerns; hence critics may miss enterprises and concerns, and the general consumer may thereby miss opportunities. Critics also have varying abilities to conduct a fair and unbiased evaluation of a prospect.

Another avenue to provide users and consumers access to evaluations or ratings of concerns are “rating sites”, considered here as web-based sites in which consumers of enterprise products and services are allowed to enter ratings, which are aggregated and reported on-line to other uses. Such an approach is useful in providing a broad array of opinions, but may be limited by the expertise of the many individual evaluators, including bias, lack of expertise as to the products or services being evaluated, or poor rating acumen.

### BRIEF SUMMARY OF THE INVENTION

Given the limitations set forth above, it is desirable to have additional means to provide enterprise evaluation to interested parties, such as users, consumers, and purchasers. One resource involves using specific users, notably those that regularly attend, consume, utilize or purchase relevant services or products, to help provide such enterprise evaluations in combination with a unique method of data aggregation and evaluator feedback.

Employing techniques of the present invention seeks to overcome or at least minimize the wide range of abilities and biases among evaluators, and in this way, generate a rating that is more accurately indicative of each enterprise.

As noted in the Background section, there is a general need to evaluate an enterprise in a wide range of circumstances, including for example the evaluation of product and service providing concerns at many enterprise levels. Such evaluations often utilize what are commonly referred to as “critics”, and such critics generally have subject expertise and may often cover certain geographic regions. A key limitation, however, is that critics are unable to cover all regions and all enterprise concerns; hence consumers may miss concerns, and concerns may miss sales opportunities. Given such evaluation limitations, it is desirable to have additional means to provide enterprise evaluation to interested parties, such as consumers, and to provide additional enterprise and business opportunities to those being evaluated, such as service providers and product providers.

The current invention provides a solution to the aforementioned limitations of enterprise evaluation processes by leveraging a new resource of large-scale evaluation and evaluator feedback. Focusing on the example case of restaurants, many potential evaluators are “regulars”, meaning they may regularly dine out, including a specific food type, or even frequent specific venues or regions. Such regular diners often develop a deep understanding of a specific foods and services, and often show a high level of commitment to the dining community.

Other potential evaluators may include business travelers, family vacationers, students or apprentices, and other repeat consumers. Overall, such evaluators have a range of knowledge that may not be inconsistent with the knowledge of an aforementioned critic. The current invention seeks to leverage and tap the power of such users and consumers, who are not considered formal “critics,” to assist with enterprise evaluation. Thus, the present invention seeks to use actual consumers and users as evaluators in combination with iterative feedback of the evaluators.

The totality of ratings from all evaluators (e.g., all users and consumers) for a specific enterprise concern (e.g. specific restaurant, hotel, physician, or tour guide), generates a crowd-sourced rating for that concern.

The concept of “crowdsourcing” has grown in recent years, and is perhaps most common in the rating of restaurants, hotels, retailers and professional service providers (e.g. physicians or dentists). Merriam-Webster defines crowdsourcing as “the practice of obtaining needed services, ideas, or content by soliciting contributions from a large group of people and especially from the online community, rather than from traditional employees or suppliers.”

If one considers the case of crowdsourcing in the context of the current invention, the “traditional employees or suppliers” would be considered traditional critics, for example travel critics or food critics, often employed by newspapers or other media venues, and the “large group of people” would be considered the aforementioned users and consumers that utilize, consume, purchase, etc. the enterprise concerns being evaluated.

One potential drawback of applying simple crowdsourcing techniques and metrics to enterprise evaluation, such as evaluation of a hotel or restaurant, is the potential disparity of the talent or acumen of the evaluators (e.g., the users and consumers). For example, a large

number of evaluators with varying degrees of talent-rating acumen will result in muddled enterprise evaluation that would tend to average near the mean of the rating scale. Other potential shortcomings include biases for or against a particular enterprise, for example, a friend or owner might “over rate” a particular enterprise, or a rival might “under rate” a particular enterprise. With these thoughts in mind, it is desirable and even necessary to address and mitigate such shortcomings with any proposed crowdsourcing approach to enterprise evaluation.

The current invention describes an approach to crowdsourcing as applied specifically to enterprise evaluation, including but not necessarily limited to, the evaluation of product and service providers. To avoid the aforementioned problem of disparate evaluations by evaluators with varying degrees of evaluation acumen, including poor acumen or rating biases, the invention incorporates a novel approach to rate each evaluator, and accordingly provides a weighted enterprise evaluation from each evaluator.

As an example, all crowdsourcing members (i.e., evaluators) are themselves evaluated against a crowd-sourced rating, which is in effect a totality of the crowd-source ratings from all crowd-sourcing participants over a predetermined time. Evaluator ratings that are consistently equal to or agree closely with the totality of the crowd-sourced ratings are rated higher by assigning a higher weight to their rating. The weight may be determined, for example, by a difference between an evaluator's rating and a crowd-source rating. Those evaluators whose evaluations consistently deviate from the totality of the crowd-sourced ratings are rated lower, that is, the rating is assigned a lower weight.

The weight for each evaluator is mathematically and iteratively determined based on how close or far the evaluator's rating is from the crowd-sourced rating. Such a process is readily repeated, resulting in greater accuracy with each iteration.

Taking an example of a single enterprise concern (e.g. a specific hotel) to be evaluated, the process begins by assigning all evaluators the same weight value, and then calculating an overall rating for the concern using all evaluations of that concern. Here “overall” does not necessarily refer to all aspects of the concern within a particular field of endeavor or product offering, but rather refers to a compilation or combination of all individual evaluations of that specific enterprise concern. Since many evaluators are involved in the process, the overall enterprise rating can also be referred to as a crowd-sourced overall enterprise rating.

The weight value for each evaluator is then updated (iteratively) using the enterprise's overall rating as a parameter in certain equations defined below. Using the updated weight value for each evaluator, an overall rating for the enterprise is again determined. And using the enterprise's overall rating, the weight value for each evaluator is again updated. This iterative process continues, resulting in increased accuracy with each iteration.

The inventors have determined that after a relatively small number of iterations (six or seven in one embodiment), the weight value for each evaluator converges to a final weight value. This final weight value accurately represents the weight that should be applied to ratings supplied by that evaluator. All evaluations, as contributed by all evaluators, with each evaluator assigned a weight value to be applied to all his/her evaluations, are combined to generate a more accurate (as compared with the use of raw evaluations with no assigned weights) crowd-sourced overall enterprise rating.

The concepts of the invention can be applied to any number of evaluators and any number of enterprise concerns.

In simple terms, the weighted-average approach allows the more “accurate” evaluators (users and consumers, for example) among the crowdsourcing participants to have a greater influence, and likewise reduces the influence of less accurate or biased crowdsourcing participants, in the final crowd-sourced overall enterprise rating.

Because the weight assigned to each evaluator's rating is updated with each iteration, the accuracy of the overall or totality of the enterprise evaluation ratings increases, as compared to any rating by an individual within the crowdsource or as compared to a simple (i.e., unweighted) crowd-sourced arithmetic mean (i.e., an unweighted average).

The current invention also encompasses a social media aspect, as evaluators comprise a social network or social fabric, for example with the same evaluators repeatedly using or purchasing from similar enterprises. As the crowdsourcing participants participate in the enterprise evaluation process (and themselves are rated according to the concepts of the present invention) it is expected that camaraderie, fellowship, and friendly competition will ensue, reinforcing participation of the evaluators and their commitment to accuracy, thereby further ensuring success of the current concepts and the invention.

### BRIEF DESCRIPTION OF THE DRAWINGS

FIG. 1 illustrates the primary concept of a crowdsourcing approach to enterprise evaluation, in which “Critics” evaluate “Enterprise Concerns”, which will be referred to simply as “Enterprise”, noting that the enterprise may provide a service, good, product or combination of all.

FIG. 2 illustrates the process flow for calculating an Overall Enterprise Rating, in which each of N Critics provide an Enterprise evaluation (i.e., a Player Rating) of the ith Enterprise.

FIG. 3 illustrates an algorithm for calculating an Overall Enterprise Rating, in which each of N Critics provides an Enterprise Rating. The final step provides a weighted average of the N individual Critic (i.e. Evaluator) ratings of the ith Enterprise.

FIG. 4 illustrates the overall sample rating Scale, depicted with a Minimum and Maximum scale rating, a scale Delta (i.e., an increment), and a Scale Factor Point.

FIG. 5 illustrates the sample mapping between a logarithmic value of a Critic Log Weighting Factor (CLWT) and a corresponding linear value of a Critic Weighting Factor (CWT), for a two-decade logarithmic scale example.

FIG. 6 illustrates one example of the evolution of Critic Weighting Factors (SWT) over seven iterations for a simulated population of twenty Critics and twenty Enterprises.

FIG. 7 illustrates one example of the evolution of Overall Enterprise Ratings (OR) over six iterations for a simulated population of twenty Enterprises as rated by twenty Critics.

FIG. 8 illustrates one example of the evolution of Critic Weighting Factors (CWT) over seven iterations for a simulated population of twenty Critics and twenty Enterprises.

FIG. 9 illustrates one example of the evolution of Overall Enterprise Ratings (OR) over six iterations for a simulated population of twenty Enterprises as rated by twenty Critics.

FIG. 10 illustrates the concept of a crowdsourcing approach to enterprise evaluation, in which “Critics” evaluate “Enterprises”, where Critics may be assigned specific Enterprises.

FIG. 11 illustrates a computer system for use in practicing the invention.

FIG. 12 illustrates a flow chart, for processing by the computer system of FIG. 11, implementing the invention.

### DETAILED DESCRIPTION

Detailed embodiments are disclosed herein, including specific examples; however, it is to be understood that the disclosed embodiments of the current invention are simply representative examples and representative processes, and that the system and methods described herein can be embodied in various forms. As such, the specific details, functions and processes disclosed herein are not to be considered or interpreted as limiting, but are intended as the basis and foundation for the current claims and as a representative basis for teaching one skilled in the art to employ the present subject matter in various detailed processes and methods. Furthermore, the specific terms and phrases used herein are not intended to be limited with regard to the current invention or claims, but rather, are intended to provide an understanding of and description of the concepts.

The current invention provides a practical solution to a problem inherent with using crowd-sourcing techniques to evaluate or rate an enterprise concern in a specific field (restaurant, hotel, hospital or physician's service, or a consumer good, for example). One aspect of this problem are the inevitable variations among the ratings of a single person (a specific hotel, for example) as provided by several evaluators. Additionally, certain ones of the evaluators may have a better understanding and familiarity with the field than others, again creating a distorted evaluation.

To resolve this difficulty, the crowd-sourced information is analyzed using a novel technique of evaluating the performance of the individual crowd-sourcers (i.e., evaluators) who contribute to the crowd-source information. According to the invention, a numerical weight value is applied to each evaluation, thereby creating a weighted-average crowdsourcing paradigm. The weight value is determined by comparing each evaluator's evaluation or rating with a compilation of all the crowdsourced evaluation ratings.

The approach is iterative by nature, and accordingly, the accuracy and fidelity of the weighted-average crowdsourcing approach improves with the number of iterations. Furthermore, the use of the weighted-average methodology mitigates the effect of poor (i.e., inaccurate) or biased evaluators among the individual crowdsourcing participants, while leveraging those with high acumen for quality enterprise evaluation in the field.

For the purpose of this description herein, the term “Enterprise” is defined as a business or organization or service or goods provider being evaluated by the crowdsourcing process; hence an Enterprise may be a goods or service provider, for-profit or not-for-profit, or any other enterprise concern category, such as a hotel, restaurant, professional such as a doctor or lawyer, or professional service provider such as a hospital or school. The term “Critic” is defined as a person performing the evaluation; hence a Critic is a person in the crowdsourcing “Crowd” such as a product or service consumer or any other evaluating person (evaluator) participating in the crowdsourcing process. It is not necessary nor expected that in the context of this invention that this person be a “Critic” in the conventional use of that word, where “Critic” is defined as one who professionally judges the merits of an Enterprise or Concern. The term “Consumer” is defined as a person, agency or other entity that is the recipient of the crowd-sourced information; hence a recipient of the enterprise evaluations.

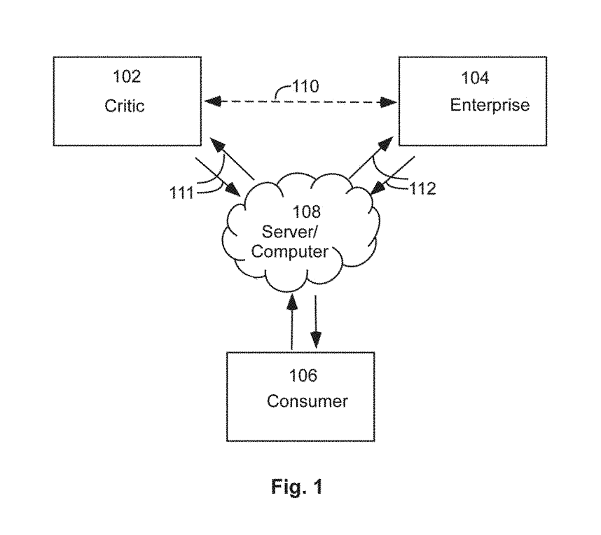

FIG. 1 illustrates the basic concept of a crowdsourcing approach to personnel evaluation (as embodied in the present invention), in which “Critics” 102 evaluate “Enterprises” 104, and a central Server/Computer 108 both compiles, calculates, and manages Enterprise ratings and Critic ratings, while also providing Enterprise ratings and other Enterprise information to Consumers 106 via a path 109. As shown by a connecting line 110 individual Critics evaluate individual Enterprises, and have access to other relevant Enterprise information, such as metrics or statistics. As suggested by two sets of arrowheads 111 and 112, both Enterprises 104 and Critics 102 may upload data to and download data from the Server/Computer 108. For example, Enterprises may upload additional performance metrics to the Server/Computer, for Critics to access and use.

The embodiment of the crowdsourcing method and system as described herein is managed/executed by the Server/Computer 108 of FIG. 1, which is implemented by one or more data processing devices, such as a central server or servers, or a central computer or computers, including for example cloud-based servers, in which said servers/computers compile and store all related data, perform relevant calculations, and provide means for user interfaces between all participants, including but not limited to Enterprises, Critics, and Consumers, as well as data managers, etc. In one embodiment, the Server/Computer 108 also provides an interface for evaluators to enter the rating for processing. The approach of the invention may also be web-based and may run on a broad array of operating systems and platforms, including but not limited to mobile devices (e.g. iOS or Android based-devices), cell phones, smart phones, tablet devices, laptop devices, PC devices, and wearable electronic devices.

As defined above, three primary categories of participants are identified, namely, Enterprises, Critics, and Consumers; however, various embodiments are not limited to these three categories. In general, according to one embodiment, Enterprises enroll, or in other words, “sign-up” for the enterprise evaluation service with the intent of being evaluated. For example, a hotel might enroll as a participant with a goal of being evaluated and subsequently increasing its business, in other words being promoted to a Consumer, to utilize or consume or purchase the enterprises good or service, that is, an overnight stay in a hotel. A hotel might enroll as a participant with a goal of increasing room rentals. A lawyer might enroll as a participant with a goal of gaining new clients. In other embodiments, the evaluators (i.e., Critics) might enter and evaluate various enterprises directly. Such examples are not considered limiting.

Upon enrollment, an Enterprise may also upload information and performance statistics or metrics (e.g., to the Server/Computer 108 as indicated by the arrowheads 112). For the example of the restaurant, such information might include awards and recognitions from a local newspaper or a Michelin rating. For the example of a lawyer, it might be membership in specific bars or ABA accreditation. Other digital media or information may also be uploaded by an Enterprise, including photographs or videos, including video of the venue or product or service, or songs and performances for the example of the musician. Additional traits that speak to the Enterprise's character may be uploaded, including scholastic data or other accolades for professional service providers, such as academic awards, and community service awards.

All such information uploaded for an Enterprise becomes linked exclusively with said Enterprise, and in aggregate forms that Enterprise's online portfolio, which is stored, compiled and managed by the Server/Computer 108 of FIG. 1.

In general, Critics (i.e., evaluators) enroll, or in other words, sign-up for an Enterprise evaluation service with the intent of providing evaluations in the context of the crowdsourcing process and method. For example, a “foodie” might enroll as a participant with a goal of evaluating restaurants, and subsequently helping restaurants to be recognized for uniqueness of cuisine, in other words by a Consumer, to patronize. As another example, a frequent or experienced business traveler might enroll as a participant with a goal of evaluating hotels and airlines. Such an example is not considered limiting of the scope of the present invention.

Upon enrollment, a Critic may also upload her/his personal information. For the example of the business traveler, such information might include frequency of travel, or regions of travel, and other information including personal contract information. Other digital media or information may be uploaded by an Enterprise, including photographs or videos. All such information uploaded for an Enterprise becomes linked exclusively with said Enterprise, and forms that Enterprise's online portfolio, and is stored, compiled and managed by the system's server or servers, such as the Server/Computer 108 of FIG. 1.

In general, Consumers enroll, or in other words, sign-up for the enterprise evaluation service with the intent of reviewing and requesting and using evaluations in the context of the crowdsourcing systems, processes, and methods of the present invention. For example, a frequent travel might enroll as a Consumer with a goal of receiving Enterprise evaluations, and subsequently helping guide travel decisions. Some participants may function as both Evaluators (Critics) and as Consumers. Such examples are not considered limiting. Upon enrollment, a Consumer may have access to Enterprise ratings and information, as described herein. Consumers will also have the ability to perform search functions, for example, searching for Enterprises by field or service, goods, geographic location, by performance metrics or personal metrics, and by the crowd-sourced rating factors, to name a few.

Consumers can also create wish lists, watch lists, directly contact Enterprises, perform Enterprise-to-Enterprise comparisons, track enterprises, request ratings of specific Enterprises, and generally use all available Enterprise information to inform decisions as to consumption of goods, products, and services. Generally, these functions are executed and/or controlled by the Server/Computer 108 of FIG. 1.

Enterprises, Critics, and Consumers may have identifiers for log-in and security reasons, which may include user names, passwords, recovery emails addresses, and other steps and practices commonly used for on-line social networks and enterprises to ensure data integrity and security.

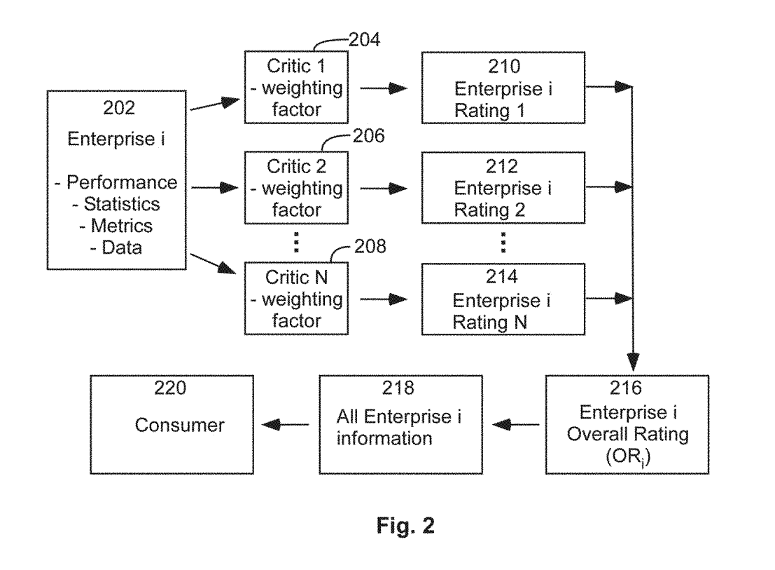

One novel aspect of the current invention is the use of a crowd-sourced based weighted average to evaluate enterprise concerns, as illustrated with the Enterprise and Critic model described above and further defined, but not limited to, the process flow diagram of FIG. 2. Here an individual Enterprise 202, designated as the ith Enterprise (Enterprise i), is rated by N different Critics, where N is greater or equal to 2. The N Critics represent crowdsourcing evaluators.

Accordingly, a unique weighting factor (sometimes simply referred to as a weight) is determined for each one of a Critic 1 204, a Critic 2 206, through an Nth Critic 208. As described herein, each Critic's weighting factor is determined based on an iterative feedback approach.

Each one of the N Critics provides a rating of Enterprise i, as depicted by a Rating 1 of Enterprise i as provided by Critic 1 (reference numeral 210), a Rating 2 of Enterprise i as provided by Critic 2 (reference numeral 212), to a Rating N of Enterprise i as provided by Critic N (reference numeral 214).

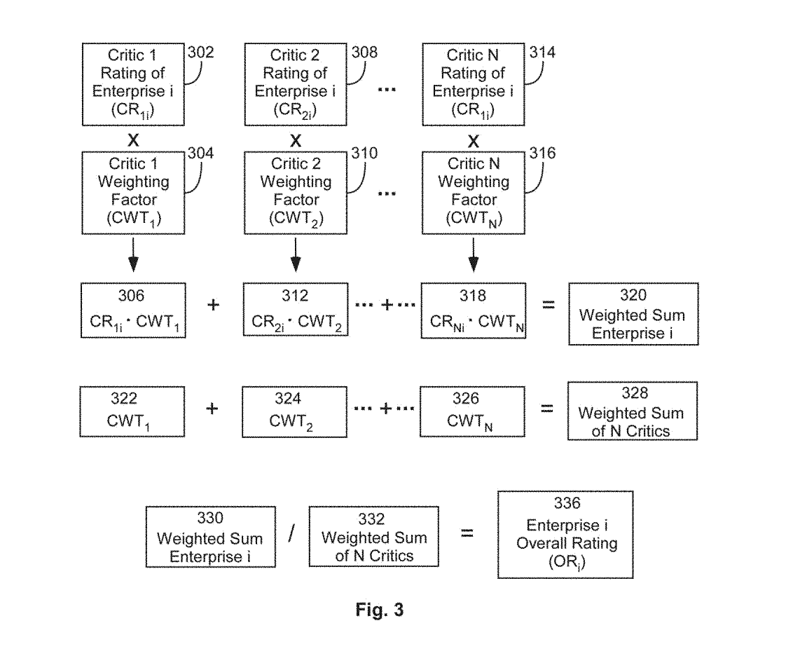

The N Critic ratings and the corresponding N Critic weighting factors (a technique for determining the weighting factors is described herein) are used to compile, as elaborated on further below with respect to FIG. 3, an Overall Rating of Enterprise i (reference numeral 216). Enterprise i (reference numeral 202) also has associated Enterprise information, such as performance metrics, statistics, traits, or other digital information or media useful for the overall assessment and enterprise evaluation of Enterprise i. All such information 218, including the Overall Rating 216, may be provided to a Consumer 220 (or Consumers), as well to the Critics 1 to N (this latter feature not illustrated in FIG. 2).

FIG. 3 provides a more detailed schematic of an algorithm to calculate the Overall Rating of Enterprise i (ORᵢ) as evaluated by N individual evaluators (i.e., Critics), where N is greater than or equal to 2. The individual Critics represent a crowd with respect to the crowdsourcing method of the invention.

Accordingly, Critic 1 provides an Enterprise Rating of Enterprise i (SR₁ᵢ) 302, which is then multiplied by the Critic Weighting Factor (CWT₁) of Critic 1 at a step 304 and stored at a step 306. In the double subscript notation of CRₙₘ, the first digit represents the nth Critic (the evaluator) and the second digit represents the mth Enterprise (the evaluee).

Similarly, Critic 2 provides a Critic Rating of Enterprise i (CR₂ᵢ) at a step 308, which is multiplied the Critic Weighting Factor (CWT₂) of Critic 2 at a step 310 and stored at a step 312. The process is repeated for all Critics until Critic N provides a Critic Rating of Enterprise i (CR_{Ni}) at a step 314, which is then multiplied the Critic Weighting Factor (CWT_{N}) of Critic N at a step 316 and stored at a step 318.

A time interval component should also be considered relative to these evaluations. Ideally it is preferred for all Critics i to supply their evaluations during a relatively short interval, a few days for example. This may be important, as if the evaluations are provided over a long time interval, they may not represent a current state of an Enterprise i. For example, if Evaluator 1 supplies an evaluation on Monday and Evaluator supplies an evaluation of the same Enterprise on Saturday, the two Evaluators may not have experienced the same level of service from the Enterprise, i.e., new process may have been initiated between Monday and Saturday that affected the quality of service provided—either better or worse. This aspect of the invention is described further below.

After the step 318, all products of the Critic Rating and the corresponding Critic Weighting Factor, 1 to N, are summed to yield the Weighted Sum for Enterprise i at a step 320.

The individual Critic Weighting Factors are then summed as also indicated in FIG. 3. Hence the Critic Weighting Factor of Critic 1 (CWT₁) at a step 322 is added to the Critic Weighting Factor of Critic 2 (CWT₂) at a step 322 and so on to a step 326 where the addition of the Critic Weighting Factor of Critic N (CWT_{N}) is added, yielding the Weighted Sum of N Critics at a step 328.

The Weighted Sum 328 of N Critics is used to normalize the Weighted Sum 320 of Enterprise i; therefore, the Overall Rating (ORᵢ) 336 of Enterprise i is defined by the Weighted Sum 330 of Enterprise i as divided by the Weighted Sum 332 of N Critics. By normalizing the weighted sum of an Enterprise, the effects of Critics with different weights are accounted for while maintaining an Overall Rating within the weighting scale. Thus, the weighted sum of a first enterprise who has been rated by Critics A and B, can be equitably compared with the weighted sum of a second player who has been rated by Critics C and D, albeit Critics A, B, C, and D have been assigned different weights.

This operation is defined by Equation (1) below.

$${OR}_{i} = \frac{{\sum }_{j = 1}^{N} {CR}_{ji} \cdot {CWT}_{j}}{{\sum }_{j = 1}^{N} {CWT}_{j}} \qquad ( 1 )$$

The use of Equation (1), as depicted by the steps and arithmetic operations depicted in FIG. 3, embodies the concept of using a weighted evaluation to calculate a weighted average, in that the evaluations of all N Critics (i.e., evaluators) are not counted equally, but instead are weighted.

Additional details of the weighting factor are provided below, but weighting factors can range over any suitable scale. For example, a 1 to 100 scale, a 0 to 1 scale, and a −1 to 1 scale, are all valid approaches for weighting factors and are not considered limiting features of the present invention.

For example, the normalization by the denominator of Equation (1), namely the Weighted Sum 328 of N Critics of FIG. 3, allows the use of any weighting factor scale, so long as the same weighting factor scale is applied to the rating by each Critic.

It is noted that the current invention reduces to a simple arithmetic mean (i.e. simple average) if the Weighting Factor of each Critic (CWTⱼ) is set to unity (or another constant value) for all Critics j=1 to N, as shown by Equation (2) here.

$${UOR}_{i} = \frac{{\sum }_{j = 1}^{N} {CR}_{ji}}{N} \qquad ( 2 )$$

where UORᵢ is the Unweighted Overall Rating of the Enterprise i. However, as can be appreciated, if the weight value associated with each Critic evaluation is the same (which in effect means there is no weight value), then the rating of one Critic's evaluation is not considered more important or less important than the evaluation rating of other Critics.

Comparison of Equation (1) and Equation (2) reveals a substantial difference between the embodiment utilizing the weighted evaluator average to produce an Overall Rating (ORᵢ) and a simple unweighted evaluator average to produce an Unweighted Overall Rating (UORᵢ) of the Enterprise i, that is, the use of the Critic Weighting Factors. Clearly Equation (1) provides a more accurate evaluation of the Enterprise, and progressively becomes more accurate with each iteration, as detailed below in one embodiment.

The concepts described herein to yield a crowd-sourced Overall Rating (ORᵢ) of any Enterprise i can also be used to calculate any number of specific performance metrics for Enterprise i using an identical process. The Overall Rating is considered the summary rating, encompassing the overall or aggregate assessment of a given Enterprise. However, the evaluation of Enterprise i is not limited to a single metric and a single overall rating. Accordingly, Enterprise i could be evaluated using the same weighted-averaging approach for any number of attributes or performance metrics as evaluated by the crowd of crowd-sourcers.

Generally, the OR overall rating described herein encompasses many elements of the Enterprise's attributes, e.g., cleanliness or speed of service for a restaurant. Thus, the Critic's rating represents a composite rating for the Enterprise.

Using the hotel example, in lieu of using an Overall Rating for the hotel (i.e., one that combines many different aspects or attributes of the hotel's services) the evaluators may in addition rate and therefore input unique or individual ratings for individual hotel attributes, such as cleanliness, quality of beds, level of noise, curtesy of staff, location, etc. The algorithm of FIG. 3 can be used for each unique or individual rating and thus a weighted overall average rating (ORᵢₛ) for each unique or individual performance metric can be determined, with the additional subscript “s” denoting a specialty rating; such additional ratings may be considered specialty ratings, or auxiliary ratings or attribute ratings.

The rating of any specific metric must entail a rating scale, and there exists a plurality of rating scales such as an integer scale from 1 to P, (such as 1 to 5; or 1 to 10), or a Likert scale such as ranging from Strongly Dislike to Strongly Like. Scales may also be “continuous” in nature, such as a sliding bar on a mobile app device from 1 to 10; however, any “continuous” scale will be digitized to a discrete resolution value to complete the analysis; therefore, while a continuous sliding scale may be utilized for any rating scale as entered by the evaluators (Critics), for practical consideration, all scales are considered as having a discrete increment over some finite range.

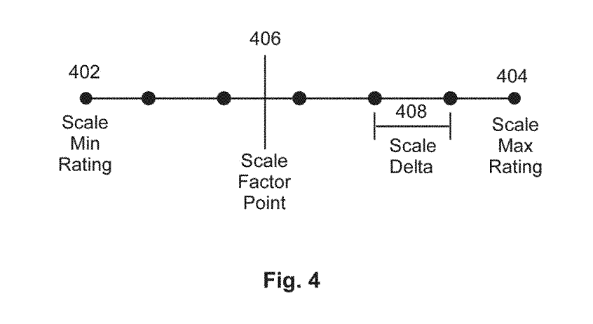

FIG. 4 illustrates for purposes of defining the Critic Weighting Factors, a proposed Rating Scale, as defined by a Scale Minimum Rating 402 and a Scale Maximum Rating 404, along with a Scale Delta 408 (i.e., a scale increment). For example, a five-point integer rating scale of 1,2,3,4,5 would have a Scale Minimum Rating of 1, a Scale Maximum Rating of 5, and a Scale Delta of 1. Similarly, a 7-point integer rating scale of 1,2,3,4,5,6,7 would have a Scale Minimum Rating of 1, a Scale Maximum Rating of 7, and a Scale Delta of 1. Such examples and scales are not considered limiting.

FIG. 4 also depicts a Scale Factor Point 406, which is defined as a value greater than the Scale Minimum Rating and less than the Scale Maximum Rating, but the Scale Factor Point may not be limited to discrete integer values.

Using the above example of the five-point integer scale, the Scale Factor Point could be any value greater than 1 and less than 5, such as 2.5, or 3, or 3.5, etc. As detailed below, the Scale Factor Point is used to define the Critic Weighting Factors, that is, the weighting factors used to weight the individual evaluator's ratings.

In one embodiment, a logarithmic scale is used to calculate the Critic Weighting Factors (CWT) for any given Critic, although such an approach is not limiting of the scope of the present invention.

To calculate the Critic Weighting Factor for an individual Critic j, the enterprise evaluations of Critic j are compared to the enterprise evaluations of the entire crowd (crowd-sourced) of evaluators. In other words, every Enterprise i who was rated by Critic j is used to evaluate the performance of Critic j. Letting M be the number of Enterprises rated by Critic j, Equation (3) is given as

$${CDR}_{j} = \frac{{\sum }_{i = 1}^{M} Abs ( {CR}_{ji} - {OR}_{i} )}{M} \qquad ( 3 )$$

where the parameter CDRⱼ is defined as the Critic Differential Rating of an individual Critic j. As can be seen from equation (3) above, it is calculated as the sum of all absolute values of the difference between the Critic Rating of Enterprise i by Critic j (CRⱼᵢ) and the Overall Rating of Enterprise i (ORᵢ) by all Critics who evaluated Enterprise i. That value is divided by M Enterprises as rated by Critic j (which normalizes the equation by M). Note that ORᵢ is defined above, and is based on the crowd-sourced average rating of the ith Enterprise per Equation (1) above.

For example, if Critic j has rated 10 unique Enterprises (M=10), CDRⱼ is calculated by taking the absolute value of Critic j's rating of Enterprise 1 minus Enterprise 1's Overall Rating, namely ABS(CRⱼ₁−OR₁), added to the absolute value of Critic j's rating of Enterprise 2 minus Enterprise 2's Overall Rating, namely ABS(CRⱼ₂−OR₂), and so on until finally adding the absolute value of Critic j's rating of Enterprise M minus Enterprise M's Overall Rating, namely ABS(CR_{jM}−OR_{M}). The resulting sum is then divided by M.

A few observations regarding Equation (3) are noted here, but not considered limiting to the follow-on calculation of the Critic Weighting Factor, which directly follows from the CDR. If Critic j is defined as a “Perfect Critic”, meaning that Critic j's rating of each and every Enterprise as rated by Critic j is identically equal to the crowd-sourced Overall Rating of each and every Enterprise, then the Critic Differential Rating of Critic j would be identically equal to zero. Accordingly, the lower limit of the Critic Differential Rating of any given individual Critic is zero.

On the other end of the spectrum, the maximum theoretical value of the Critic Differential Rating approaches the value of the range of the corresponding Rating Scale; hence of the difference between the Scale Maximum Rating 404 and the Scale Minimum Rating 402, with reference to FIG. 4. Such a maximum theoretical value (Maximum Rating 404 minus Minimum Rating 402) would be approached by Scout j only if every Enterprise evaluated by the crowd received a near-unanimous rating of either the Scale Minimum or the Scale Maximum, and for each respective case, the Critic j rated the respective Enterprise at the opposite end of the Scale of FIG. 4. Such a scenario is highly unlikely but does illustrate the upper limit approached by the Critic Differential Rating.

A more practical benchmark for comparing an individual Critic j′s performance to a measure of “worst case” performance uses a Scale Factor Point 406 as illustrated in FIG. 4. Letting the Scale Factor Point be somewhere near the center of the Scale Range, for example, defining the Scale Factor Point as equal to one-half of the Scale Maximum Rating, provides a reasonable starting point, although as noted above, the Scale Factor Point may be set anywhere between the Minimum Scale Rating and the Maximum Scale Rating. If for example, the Rating Scale depicted in FIG. 4 is a seven-point integer scale, with Scale Minimum Rating 402 set to 1 and the Scale Maximum Rating 404 set to 7, the Scale Factor Point 406 as approximately illustrated is equal to 3.5.

While the examples above are not limiting, the Scale Factor Point represents a value reflective of the upper “practical” bound of the Critic Differential Rating CDR as defined by Equation (3), notably when the Scale Factor Point is set equal to or approximately equal to one-half of the Scale Maximum Rating.

Supporting logic suggests that most enterprise populations being rated will follow some distribution across the Rating Scale, with some corresponding arithmetic mean and standard deviation. For example, the population of ratings may be given by a normal (i.e., Gaussian) distribution, or a log-normal distribution, with the mean value is expected to fall within the Scale Range, even near the center of the Scale Range.

Accordingly, for the example of a seven-point scale, the mean Overall Rating of many numbers of individual Enterprises may fall in the range of 3 or 4 or 5. Therefore, even a “poor” Scout who is consistently rating Enterprises at the extremes of the Rating Scale (i.e., giving 1's or 7's ratings for an exemplary seven-point scale) would be expected to yield a Critic Differential Rating in the range of 3 or 4. As such, a Scale Factor Point of roughly one-half of the Scale Maximum Rating becomes a reasonable estimate of the practical upper limit of the Critic Differential Rating. Such an estimate is not limiting in any way to the algorithms presented here, but only illustrates the concept of calculating the Critic Weighting Factor from the Critic Differential Rating as calculated from Equation (3).

Using the aforementioned Critic Differential Rating (CDRⱼ) (from Equation (3)) for a given Critic j, and the Scale Factor Point (SFP), the Critic Log Weighting Factor for Critic j (CLWTⱼ) is defined by Equation (4):

CLWTⱼ=2·[1−(CDRⱼ/SFP)] (4)

as illustrated for a logarithmic scale of two decades as denoted by the pre-multiplier of 2 as the first term in Equation (4). For example, if a three-decade logarithmic scale is used, the 2 is replaced by a three, and so on, although such examples are not considered limiting. As observed in Equation (4), if the “perfect” Critic j had a corresponding CDRⱼ equal to zero, as described above, the term inside of the bracket is reduced to 1, and the resulting CLWT is calculated as 2, which is the maximum weight value for the example of the two-decade logarithmic scale.

On the other hand, for the example of a “poor” Critic j, there would be a corresponding value of CDRⱼ in the approximate value range of the Scale Factor Point SFP, if the SFP is selected as discussed above. Accordingly, the inner parenthetical term will be equal to unity or near unity, and therefore the bracket term will equal to or be approximately near zero. For such a case, the resulting value of CLWT would be near zero, corresponding to the lower weight value (i.e., minimum value) for the example of the two-decade logarithmic scale.

The example defined by Equation (4) is not limiting in any way, as various logarithmic scales could be utilized, but the general result is the CLWTⱼ value of Critic j will tend to zero (i.e. the lower end of the scale) for “poor” Critics, and will tend to the upper value, given by 2 for this example (i.e. the upper end of the scale) for “accurate” Critics. Additionally, the logarithmic critic rating factor can be converted to a linear-scale scout rating factor by using Equation (5) as will be described below.

For some scenarios, the CLWT value may be used directly as the Critic Weighting Factor (see FIG. 3 for example), for which case CLWTⱼ would be set equal to CWTⱼ. Such a scenario defines only one embodiment and is not considered limiting of the scope of the invention.

For other scenarios, it is desirable to map the Critic Log Weighting Factor CLWT to a linear map, for example, by using Equation (5)

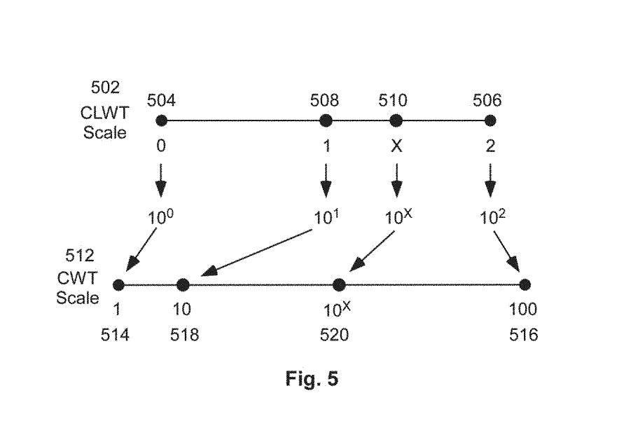

CWTⱼ=10^{CLWT}^{ⱼ} (5)

where the Critic Weighting Factor of Scout j, that is CWT_{J}, is calculated by raising the log-base 10 to the power of the Critic Log Weighting Factor CLWT_{J}, as defined for example by Equation (4). As illustrated in FIG. 5 for a two-decade log scale, Equation (5) serves to map the logarithmic scale to a final linear scale, in this case a linear scale from 1 to 100. For example, the CLWT scale 502 having a value of zero at a point 504 maps to 10 raised to the zero power, which produces a CWT value of 1 at a point 514.

On the other end of the scale, a CLWT at a point 506 with a value of 2 maps to 10 raised to the second power, which produces a CWT value of 100 at a point 516. In this way, the two-decade logarithmic scale of 0 to 2 is mapped to a linear scale of 1 to 100.

For intermediate values, a CLWT having a value of 1 at a point 508 maps to 10 raised to the first power, which produces a CWT value of 10 at a point 518. A generic CLWT value given by x at a point 510 maps to a value of 10 raised to the power of x at a point 520 on the linear scale. The above examples are not considered limiting, but in general, the more perfect Critics are transformed to the higher range of the CWT scale, while poor (i.e., inaccurate) Critics are transformed to the lower range of the CWT scale.

An additional advantage of the embodiment discussed above is that even negative values of the CLWT map to positive CWT values, maintaining positive weighting factors for all Critics. For example, if the Critic Differential Rating for Enterprise j (CDRⱼ) is slightly larger than a defined value of Scale Factor Point SFP, then as given by Equation (4), the quotient of CDRⱼ as divided by SFP is greater than one, and the difference within the bracket of Equation (4) is negative, and thus the value of CLWT for Enterprise j will be a negative number, although a generally small (i.e., near zero) negative number.

Under this scenario, the final Critic Weighting Factor, as given by Equation (5), is calculated as 10 raised to the negative number of CLWT, resulting in a number bounded by zero and 1. Accordingly, the overall linear range of Critic Weighting Factors is practically extended slightly, to range from zero to the maximum value. The practical outcomes are two-fold, as such logarithmic-to-linear mapping generates a positive overall Critic Weighting Factor range, and confines extremely poor Critics (i.e. those with poor enterprise evaluating acumen or a strong rating bias) to the extreme low end of the Critic Weighting Factor scale (i.e., between 0 and 1), thereby minimizing their influence on the crowd-sourced evaluation (i.e., rating) and improving the accuracy of the current invention.

The above treatment of the calculation of Critic Weighting Factors shows typical embodiments that leverage the logarithmic scale to help spread the Critic Weighting Factors over the positive, linear scale, but are not considered as limiting of the scope of the present invention. Any number of scales, such as logarithmic, linear, power, exponential, etc., may be used as readily apparent to anyone skilled in basic algebra and mathematics.

Furthermore, the use of Equation (3) to calculate a Critic Differential Rating is not considered limiting, as many other approaches are available for assessing the agreement between sets of numbers, as in the agreement between individual Critic Ratings and the Overall Ratings of the crowd-sourced data. Common approaches might involve the use of a root mean square error (RMS), a standard error, or any other statistical method of assessing a quantifiable measure of agreement. Furthermore, more sophisticated methods of weighting the enterprise evaluators as compared to the crowdsourcing response are available, such as neural networks, principle components analysis, partial least squares, and least squares approaches, as such techniques are readily apparent to those skilled in art of data analysis and quantification of error.

Recall that one objective of the present invention is determining a weighting factor to be applied to the enterprise rating made by each evaluator. The weight value assigns a relative worth to each rating that is contributed to generate the crowd-sourced rating.

To calculate the Overall Rating (OR) from Equation (1), each critic submits a Critic Rating (CR) and each critic is assigned an identical initial Critic Weighting Factor (CWT) Value. The Overall Rating for an Enterprise i can be calculated from Equation (1).

Equation (3) is then used to calculate the Critic Differential Rating followed by Equation (4) to calculate the Critic Log Weighting Factor (CLWT) or the Critic Weighting Factor (CWT) using Equation (5).

Since Equation (1) is normalized by the denominator, either the CLWT or the CWT (or a different weighting factor) can be used in Equation (1).

Equation (1) is now executed again with the updated value for the critic weight as determined from Equation (4) or (5) to generate a new overall enterprise rating.

Equations (3) and (4) (and (5) if required) are executed again using the updated overall rating to again generate an updated critic rating weight.

The process continues as described through a finite number of iterations until the rating weight for each critic (the weight for each critic being the ultimate objective of this effort) converges to a final value (i.e., one that does not change significantly with additional iterations).

These converged weight values are now used in Equation (1) to determine the overall rating of an enterprise, that is, a crowd-sourced overall rating, but with each rating value weighted in the crowd-sourced rating calculation. The result, by employing the present invention is a more accurate crowd-sourced overall rating.

As described, the Equations and resulting numerical values can be applied to any number of enterprises (i) and any number of critics (j).

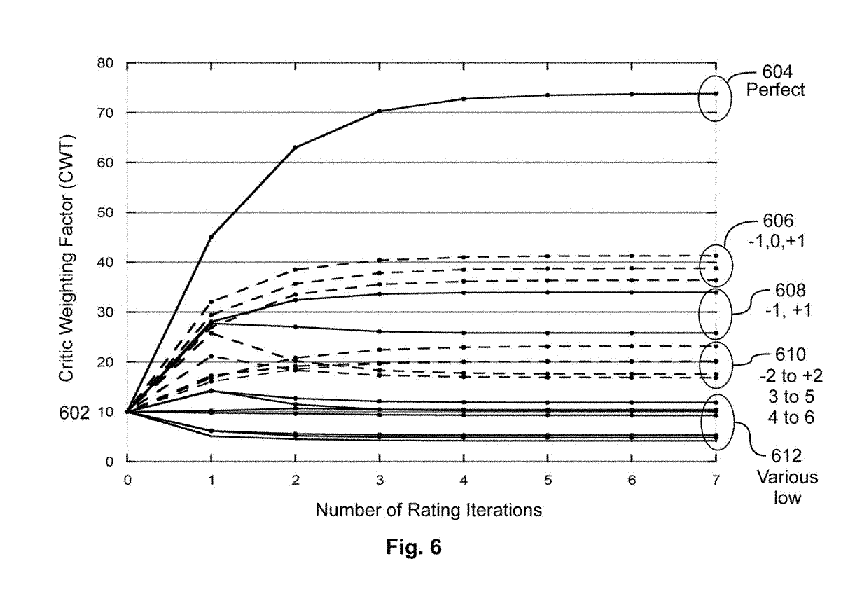

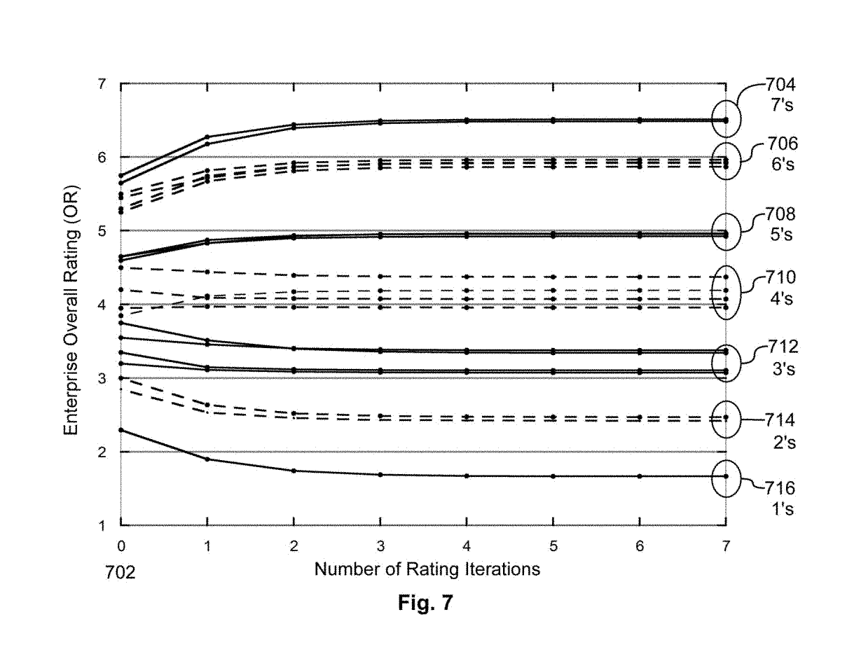

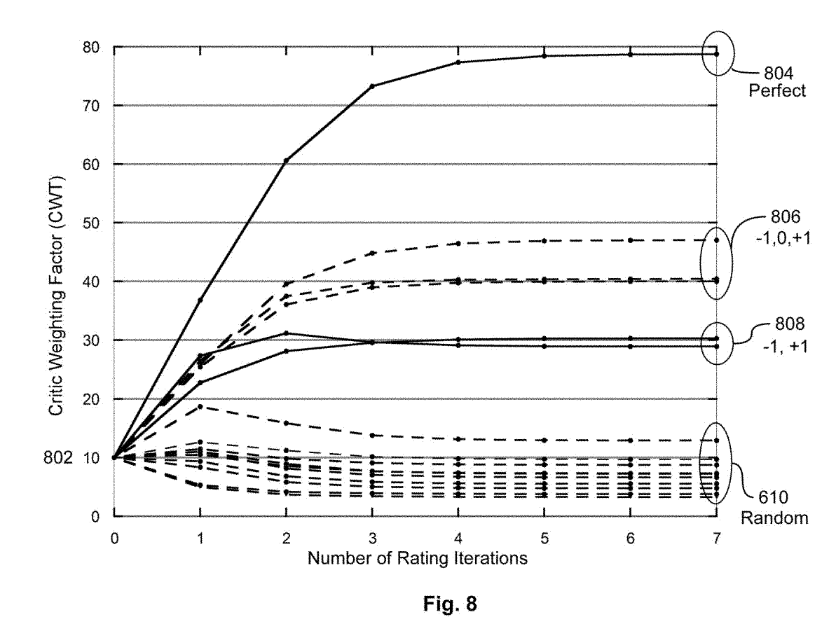

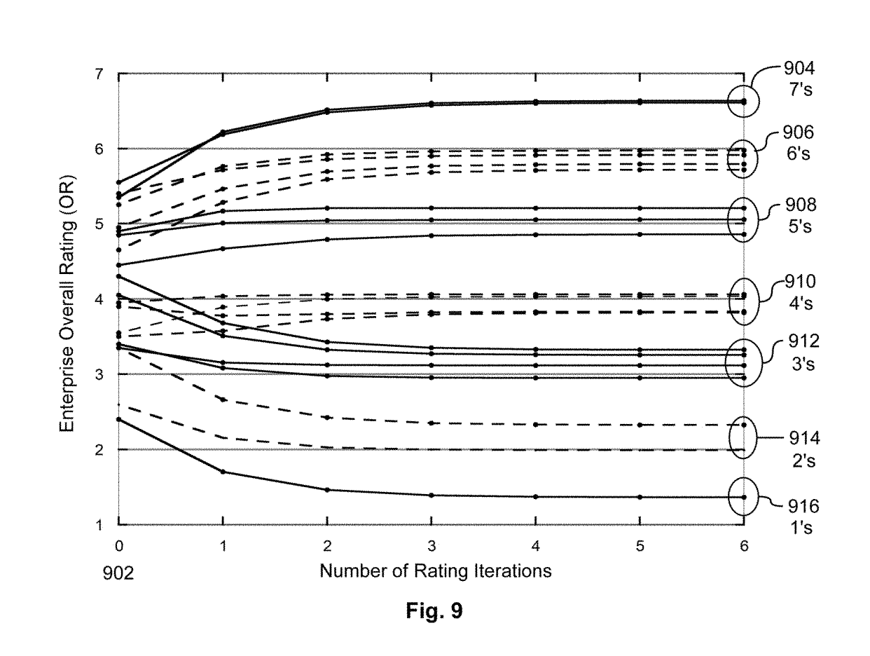

The results of the iterative process are shown in FIGS. 6 and 8 with respect to updating the critic weighting values for a plurality of critics. And the process of iterating with respect to the overall ratings for an enterprise is illustrated in FIGS. 7 and 9. These Figures are described further below.

Turning now to FIGS. 6 and 7, they illustrate one exemplary application of the current invention using a 7-point rating scale (i.e., 1 to 7) in combination with a two-decade logarithmic scale for evaluating the Critics (i.e., for evaluating each critic as to the accuracy of his/her ratings as compared to the crowd-source rating).

For this example, an array of 20 Critics and 20 Enterprises has been created, with each Enterprise randomly assigned an Overall Rating (i.e., an enterprise evaluation) on the scale of 1 to 7, using only integer values in this example. These randomly assigned ratings may be considered the “true” Rating of each Enterprise, (i.e., the rating that represents the Enterprise's true or actual abilities in this simulation).

The 20 Critics are then assigned various levels of evaluating acumen (i.e., enterprise rating acumen), for example, three Critics are defined as “perfect” Critics, in that they rate each of the 20 Enterprises perfectly. In other words, their rating is set to match the “true” Rating of each Enterprise.

Three Critics are defined to randomly assess a rating within a range of +1 and −1 of the “true” rating. For example, if the true rating was 4, each of these three Critics would rate the Enterprise as either 3, 4 or 5, with the specific rating value assigned by each Critic determined randomly.

Two Critics among the 20 Critics are defined as either always 1 higher than the true Rating or always 1 lower than the true Rating. Hence if an Enterprise had a true Rating of 5, one of these Critics would rate the Enterprise a 4, and one would rate the Enterprise a 6.

Five Critics are assigned to randomly rate the Enterprise between +2 and −2 of the true rating, or each Enterprise is randomly assigned a fixed rating between 3 and 5 or between 4 and 6, which reflects an evaluators tendency to put all enterprises in the same mid-scale bracket.

Five Critics are designated as always giving a rating that is 2 to 3 ratings below the true Rating, or giving a rating between 2 and 4 or between 5 and 7, or giving either all ratings of 2 or all ratings of 6.

Finally, two Critics are designated to provide a totally random rating between 1 and 7.

To begin, each Critic is assigned a Critic Log Weighting Factor of 1, which corresponds to a linear-scale Critic Weighting Factor of 10.

FIG. 6 illustrates the evolution of the Critic Weighting Factors (CWT) over 7 iterations of evaluating the Critic performance, with all 20 Critics beginning with a CWT of 10, as indicated by a reference numeral 602, at zero iterations. At the first iteration, the CWT values begin to diverge, and by the second iteration each Critic CWT value has begun to move toward an accurate reflection of the rating acumen of each Critic, as defined above. By the 7^{th} iteration, after applying Equations (1), (3) and (4), (5) iteratively as described above, each CWT value has asymptotically approached its final value, which accurately reflects the rating acumen of each Critic.

The three perfect Critics converge to a CWT value of 73.8 as indicated by a reference numeral 604. In a sense, a rating of 73.8 is a “perfect” rating in that it is the highest rating, and thus the ratings of these three Critics carry the most weight in the crowd-sourced rating.

Note that it is difficult, if not impossible, for even a perfect Critic to attain a perfect weighting factor of say 100, because others in the crowd are not equally perfect. Even though the weighting factors of other Critics are much lower, they drive the crowd-sourced weighted average away from even the perfect Critic. The crowd-sourced rating tells us the answer, but then Critics are matched against the answer, which further refines the answer, ad infinitum.

The three Critics whose ratings are always within the +/−1 range converged to CWT values of 36.4, 38.8 and 41.3 as indicated by a reference numeral 606.

The two Critics always off by 1 (i.e., 1 higher or 1 lower) from the true value converge to CWT values of 25.8 and 34.0 as indicated by a reference numeral 608.

The five Critics within +2 and −2 of the true value, or giving a rating of between 3 and 5 or between 4 and 6 within the true value, converged to CWT values from 16.9 to 23.2 as indicated by a reference numeral 610, with an average value of 19.6.

The seven remaining Critics, including the two random Critics, converged to CWT values between 4.8 and 11.0 (see reference numeral 612), with an average value of 7.99.

Thus, the data in FIG. 6 demonstrate that accurate Critics (i.e. those with enterprise evaluation acumen) earn higher Critic Weighting Factors, as compared to inaccurate Critics, including for some cases more than one of order of magnitude (i.e., a factor of 10) (4.8 vs. 73.8) separating the best Critics as designated by the reference numeral 604 from the worst Critics as designated by the reference numeral 612.

FIG. 7 illustrates the evolution (as the number of rating iterations increases) of the corresponding 20 Enterprises as evaluated by the 20 Critics of FIG. 6. The Enterprises are initially evaluated using what is effectively an Unweighted Overall Rating (UOA) rating per Equation (2), even though evaluated using Equation (1), because all Critics start with the identical Critic Weighting Factor of 10 as illustrated in FIG. 6. As discussed above, therefore Equation (1) reduces identically to Equation (2).

The initial Overall Ratings (OR) of the 20 Enterprises range from about 2.25 to 5.75, and when compared to the “true” Enterprise ratings, the average error in evaluating the Enterprises by the 20 Critics is 20.4%, and the maximum error in rating any Enterprise among the 20 Enterprises is 130%. Because the simulation performed here is initiated with a “true” assumed rating, the error is readily evaluated by the difference between the true rating and the weighted Overall Rating, allowing direct calculation of the average error over the 20 enterprises as well as the maximum error. This starting point illustrates the concept detailed above with crowdsourcing tending to pull Enterprise ratings to the middle of the Rating Scale if no Critic Weighting Factors are used, resulting in a less accurate final rating for each Enterprise.

Toward this end, FIG. 7 illustrates the accuracy introduced by using the Critic Weighting Factors (i.e., by rating the personnel evaluators) over 6 rating iterations. FIG. 7 separates the 20 Enterprises into rating groups after the 6 iterations of Critic ratings and updating of the Critic Weighting Factors as discussed above in conjunction with FIG. 6.

As shown, the Enterprises with true Ratings of 7 cluster near an Enterprise Overall Rating (OR) value of 7 (as indicated by a reference numeral 704). The ratings do not converge exactly to 7 as such a result requires that all Critics rate a Player with a 7. The Enterprises with true Ratings of 6 cluster near an Enterprise Overall Rating (OR) value of 6 (as indicated by a reference numeral 706), the Enterprises with true Ratings of 5 cluster near an Enterprise Overall Rating (OR) value of 5 (as indicated by a reference numeral 708), the Enterprises with true Ratings of 4 cluster near an Enterprise Overall Rating (OR) value of 4 (as indicated by a reference numeral 710), the Enterprises with true Ratings of 3 cluster near an Enterprise Overall Rating (OR) value of 3 (as indicated by a reference numeral 712), the

Enterprises with true Ratings of 2 cluster near an Enterprise Overall Rating (OR) value of 2 (as indicated by a reference numeral 714), and the Enterprises with true Ratings of 1 cluster near an Enterprise Overall Rating (OR) value of 1 (as indicated by a reference numeral 716).

Following the 6^{th} iteration, noting the zeroth iteration is the simple unweighted average (i.e., since each CWT set to 10), the overall accuracy of the crowdsourcing algorithm is significantly improved, with an overall average error in evaluating Enterprises by the 20 Critics now reduced to only 9.1%, a more than two-fold improvement from the simple unweighted average. The maximum error is also reduced more than two-fold to 66.5%.

FIGS. 8 and 9 illustrate a second exemplary embodiment of the current invention using the 7-point rating scale (i.e., 1 to 7) in combination with a two-decade logarithmic scale for evaluating the Critics, as described in Equations (1) to (5) above.

In this example, an array of 20 Critics and 20 Enterprises is created, with Enterprises randomly assigned Overall Ratings (i.e., personnel evaluations) on the scale of 1 to 7, using only integer values. These randomly assigned ratings may be considered the “true” Rating of each Enterprise.

As with the first example, the 20 Critics are then assigned various levels of evaluating acumen, for example, five Critics are defined as “perfect” Critics, in that they rate each of the 20 Enterprises perfectly. In other words, their rating is set to match the “true” Rating of each Enterprise.

Three Critics are defined to randomly be between +1 or −1 of the “true” rating, meaning if the true rating was 4, each of these Critics would rate the Enterprise as either 3, 4 or 5, with the outcome determined randomly.

Two Critics are defined as either always 1 higher than the true Rating or always 1 lower than the true Rating. Hence if an Enterprise had a true Rating of 5, one of these Critics would rate the Enterprise a 4, and one would rate the Enterprise a 6.

Finally, ten Critics were designated to provide a totally random rating between 1 and 7. To begin, each Critic received a Critic Log Weighting Factor of 1, which corresponds to a Critic Weighting Factor of 10.

FIG. 8 illustrates the evolution of the Critic Weighting Factors (CWT) over 7 iterations of evaluating the Critic performance, with all 20 Critics beginning with a CWT of 10 initially as indicated by a reference numeral 802 corresponding to zero iterations. By the second iteration Critic CWT values are changing to reflect the actual rating acumen of each Critic, as defined above, and by the 7^{th} iteration, as applying Equations (3) to (5), each CWT value has asymptotically approached its final value.

The five perfect Critics converge to a CWT value of 78.8 (as indicated by a reference numeral 804); the three +/−1 Critics converged to CWT values of 40.0 to 47.0 (as indicated by a reference numeral 806); with an average value of 42.5.

The two Critics always off by 1 converged to an average CWT value 29.6 (as indicated by a reference numeral 808).

The 10 Critics defined as randomly rating Enterprises converged to CWT values between 3.29 and 12.9 (as indicated by a reference numeral 810), with an average value of 7.0.

The data in FIG. 8 demonstrates that accurate Critics (i.e., those with enterprise evaluation acumen) earn higher Critic Weighting Factors, as compared to inaccurate Critics, with for some cases more than a factor of 20 (3.29 vs. 78.8) separating the best Critics (as indicated by the reference numeral 804), from the worst Critics (as indicated by a reference numeral 810), or a factor of 24 times.

FIG. 9 illustrates the evolution of the corresponding 20 Enterprises as evaluated by the 20 Critics of FIG. 8. The Enterprises are initially evaluated using what is effectively an Unweighted Overall Rating (UOA) rating per Equation (2), even though actually evaluated using Equation (1), because all Critics start with the identical Critic Weighting Factor of 10 (see reference numeral 802 in FIG. 8), as discussed above, and therefore Equation (1) reduces identically to Equation (2). The Overall Ratings (OR) of the 20 Enterprises ranges from about 2.3 to 5.6 initially, and when compared to the “true” Enterprise ratings, the average error in evaluating the Enterprises by the 20 Critics is 25%, and the maximum error in rating any Enterprise among the 20 is 130%.

This starting point illustrates the concept detailed above with crowdsourcing tending to pull Enterprises's ratings to the middle of the Rating Scale if no Critic Weighting Factors are used, resulting in less accurate Enterprise ratings. Toward this end, FIG. 9 illustrates the accuracy introduced by using the Critic Weighting Factors (i.e., by rating the enterprise evaluators), showing a separation of the 20 Enterprises into rating groupings after 6 iterations of rating the Critics and updating the Critic Weighting Factors as discussed above in conjunction with FIG. 8.

As shown, the Enterprises with true Ratings of 7 cluster near an Enterprise Overall Rating (OR) value of 7 (as indicated by a reference numeral 904); the Enterprises with true Ratings of 6 cluster near an Enterprise Overall Rating (OR) value of 6 (as indicated by a reference numeral 906); the Enterprises with true Ratings of 5 cluster near an Enterprise Overall Rating (OR) value of 5 (as indicated by a reference numeral 908), the Enterprises with true Ratings of 4 cluster near an Enterprise Overall Rating (OR) value of 4 (as indicated by a reference numeral 910); the Enterprises with true Ratings of 3 cluster near an Enterprise Overall Rating (OR) value of 3 (as indicated by a reference numeral 912); the Enterprises with true Ratings of 2 cluster near an Enterprise Overall Rating (OR) value of 2 (as indicated by a reference numeral 914), and the Enterprises with true Ratings of 1 cluster near an Enterprise Overall Rating (OR) value of 1 (as indicated by a reference numeral 916),

Following the 6^{th} iteration, noting the zeroth iteration is the simple unweighted average (i.e., each CWT set to 10), the overall accuracy of the crowdsourcing algorithm is significantly improved, with an overall average error in evaluating Enterprises by the 20 Critics now reduced to only 5.9%, a more than four-fold improvement from the simple unweighted average. The maximum error is also reduced more than three-fold to 36.7%.

The above examples are not considered as limiting but are intended to show the utility of the proposed crowdsourcing approach to enterprise evaluation using an approach of weighted averages of the individual evaluator ratings (i.e., the crowd-sourcers) using a feedback approach by iteratively comparing the individual evaluator acumen to the overall weighted crowd-sourced enterprise evaluations.

The above examples also show the utility of the logarithmic approach to assessing the accuracy of individual Critics in combination with a linear mapping through the log-scale, as the convergence of Critic Weighting Factors is rapid (See FIGS. 6 and 8), thereby ensuring not only accurate crowdsourcing but fast convergence rates.

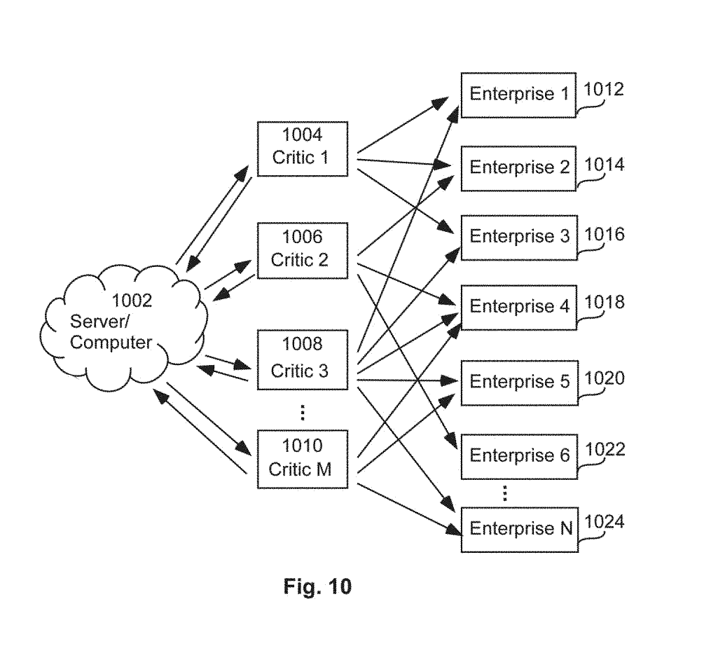

Other methods may be used to further improve the accuracy of the crowdsourcing algorithm, such as the assignment of Enterprises to various Critics, as illustrated in FIG. 10. Consider the controlling server and host computer systems 1002 in combination with a network of M Critics and N Enterprises to be evaluated. Critics may be assigned to evaluate specific Enterprises, for example, Critic 1 (designated by a reference numeral 1004), may be assigned to rate Enterprise 1 (designated by a reference numeral 1012), Enterprise 2 (designated by a reference numeral 1014), and Enterprise 3 (designated by a reference numeral 1016).

Critic 2 (designated by a reference numeral 1006), may be assigned to rate Enterprise 2 (designated by a reference numeral 1014), Enterprise 4 (designated by a reference numeral 1018), and Enterprise 6 (designated by a reference numeral 1022).

Critic 3 (designated by a reference numeral 1008), may be assigned to rate Enterprise 1 (designated by a reference numeral 1012), Enterprise 3 (designated by a reference numeral 1016), Enterprise 4 (designated by a reference numeral 1018), Enterprise 5 (designated by a reference numeral 1020), and Enterprise N (designated by a reference numeral 1024).

Critic M (designated by a reference numeral 1010), may be assigned to rate Enterprise 4 (designated by a reference numeral 1018), Enterprise 5 (designated by a reference numeral 1020), and Enterprise N (designated by a reference numeral 1024).

With such a scenario as described above and illustrated with FIG. 10, the assignment of Critics may be made using many different models or combinations of models. For example, Critics may be assigned Enterprises such that each Critic evaluates some minimum threshold of Enterprises; or Critics may be assigned such that each Enterprise is ensured to be evaluated by some minimum number of Critics; or Critics may be assigned Enterprises to evaluate that are in a certain geographic region (i.e., a region not generally associated with a Critic's home area); or Critics may be assigned Enterprises based on the type of Enterprise as compared to the Critic's ability (i.e., acumen or accuracy) at evaluating such an Enterprise. Such examples are not considered to be limiting, and any number of approaches for assigning Critics and Enterprises are available for those skilled in the art of automated assignments, mapping, optimal network configuration, and the like.

Furthermore, it is expected that Critics may self-select Enterprises to evaluate, based on personal preferences, home areas, personal experiences and professions, Enterprises that “catch their attention”, Enterprises which are mentioned by friends or other Critics, Enterprises followed or mentioned by local media outlets, or the like.

In general, Critics may be able to update their evaluation of a specific Enterprise, and any number of approaches for accommodating such an update is envisioned. For example, the Critic's prior rating may be replaced by the new rating, or the Critic's new rating may become an average of the original and new rating, or some weighted average of the original and new rating. Such examples are not to be considered as limiting, with many such approaches possible as available to those skilled in the art of averaging multiple inputs.

It is important to consider the potential of a Critic to attempt to manipulate his or her Critic Weighting Factor by updating their own ratings of given Enterprises as they determine an Enterprise or Enterprises Overall Ratings. Such potential is mitigated by making use of the Critic's original rating or ratings as described above, or by limiting knowledge of Enterprise Overall Ratings to individual Critics.

In general, Critics may communicate with other Critics and form social networks of Critics, for example, with friends or companions, especially friends or companions that frequent the same events or venues. For examples, a group of Critics may dine together each week and sit together, and such Critics may link to each other through the central server and communicate about upcoming events or certain Enterprises.

Although described in some places and examples above in the context of restaurants or hotels, the concepts of the invention can be applied to other circumstances involving evaluation and rating of any business concern, whether service or product providers. But generally, as can be inferred from the above discussion of the details of the invention, the inventive concepts are most applicable to situations that involve a crowd base (e.g. frequent travelers) and a consumer “market.”

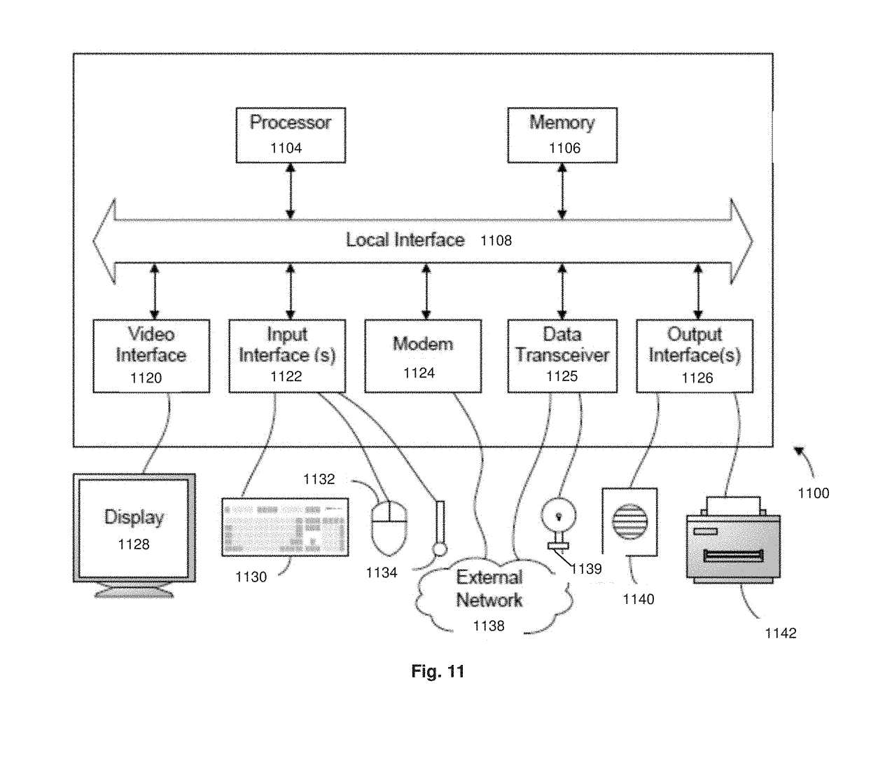

FIG. 11 illustrates a computer system 1100 for use in practicing the invention. The system 1100 can include multiple remotely-located computers and/or processors and/or servers (not shown). The computer system 1100 comprises one or more processors 1104 for executing instructions in the form of computer code to carry out a specified logic routine that implements the teachings of the present invention. The computer system 1100 further comprises a memory 1106 for storing data, software, logic routine instructions, computer programs, files, operating system instructions, and the like, as is well known in the art. The memory 1106 can comprise several devices, for example, volatile and non-volatile memory components further comprising a random-access memory RAM, a read only memory ROM, hard disks, floppy disks, compact disks including, but not limited to, CD-ROM, DVD-ROM, and CD-RW, tapes, flash drives, cloud storage, and/or other memory components. The system 1100 further comprises associated drives and players for these memory types.

In a multiple computer embodiment, the processor 1104 comprises multiple processors on one or more computer systems linked locally or remotely. According to one embodiment, various tasks associated with the present invention may be segregated so that different tasks can be executed by different computers/processors/servers located locally or remotely relative to each other.

The processor 1104 and the memory 1106 are coupled to a local interface 1108. The local interface 1108 comprises, for example, a data bus with an accompanying control bus, or a network between a processor and/or processors and/or memory or memories. In various embodiments, the computer system 1100 further comprises a video interface 1120, one or more input interfaces 1122, a modem 1124 and/or a data transceiver interface device 1125. The computer system 1100 further comprises an output interface 1126. The system 1100 further comprises a display 1128. The graphical user interface referred to above may be presented on the display 1128. The system 1100 may further comprise several input devices (some which are not shown) including, but not limited to, a keyboard 1130, a mouse 1131, a microphone 1132, a digital camera, smart phone, a wearable device, and a scanner (the latter two not shown). The data transceiver 1125 interfaces with a hard disk drive 1139 where software programs, including software instructions for implementing the present invention are stored.

The modem 1124 and/or data receiver 1125 can be coupled to an external network 1138 enabling the computer system 1100 to send and receive data signals, voice signals, video signals and the like via the external network 1138 as is well known in the art. The system 1100 also comprises output devices coupled to the output interface 1126, such as an audio speaker 1140, a printer 1142, and the like.

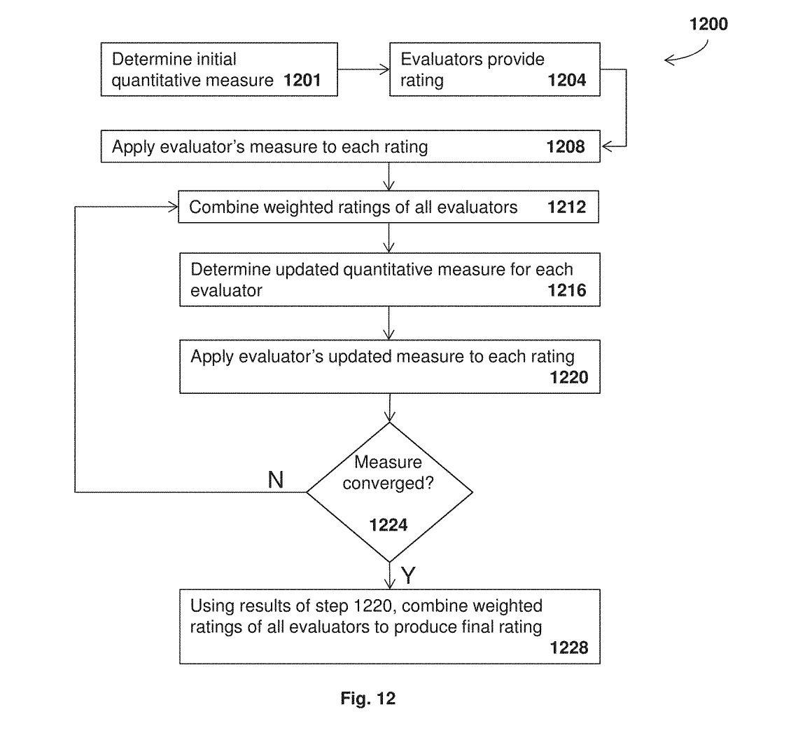

FIG. 12 is a flow chart 1200 for implementation by the computer system 1100 of FIG. 11. The flowchart 1200 begins at a step 1201 where an initial quantitative measure (e.g., a weight) is determined or assigned for each evaluator. Preferably, at this stage of the process and to simplify the arithmetic, each evaluator is assigned the same quantitative measure (e.g., numerical value). At a step 1204 each evaluator provides a rating for each enterprise in a pool of enterprises to be evaluated, perhaps as to an attribute of the enterprise product or an attribute related to an enterprise service of each enterprise.

At a step 1208 the initial quantitative measure (weight) is applied to each rating. Since each evaluator has been given or assigned a weight value, the weight of a respective evaluator is applied to the ratings of that evaluator.

At a step 1212 the weighted ratings of all evaluators are combined.

At a step 1216 an updated weight or quantitative measure is determined for each evaluator. Equations (1) to (5) above, or other suitable means, are employed to determine this updated weight.

Then at a step 1220 the updated weight or quantitative measure is applied to the initial ratings provided at the step 1204.

At a decision step 1224 the weight values are analyzed to determine if they are converging (that is, independently converging for each evaluator) asymptotically toward a final value. The user of the system must determine if that convergence has occurred, generally by reviewing the weights determined at each iteration, the resulting trend of those weight values, and the differentials determined for each successive iteration. The user will select a differential value that suggests additional iterations will not significantly affect the results.

If the result from the decision step 1224 is negative, processing returns to the step 1212 for another iteration through the steps associated with updating the weight value for each evaluator.

If the result from the decision step 1224 is positive, then the final rating is calculated at a step 1228, using the initial ratings of each evaluator, applying the last-calculated weight value, and combining all the weighted values to reach the final composite rating.

As described above, the supply of ratings by Evaluators implicitly involves a timing element. Are the conditions of the Enterprise and the services it supplies the same this week as they were last week? If not, the Evaluators may not be experiencing the same level of service this week as other Evaluators experienced last week.

Therefore, Other techniques for determining the number of iterations to convergence may depend on the nature of the evaluation. For the example of hotels, an iteration may correspond to each week of the peak tourism season in a certain area. A final rating can be calculated, based on a crowdsourced rating of several evaluators as determined according to the present invention, at the conclusion of week 1. This rating is then carried over to week 2 and serves as the initial rating for the week 2 evaluations. This process continues by carrying over the evaluation at the end of each week until the last week of the tourism season, at which point the final evaluation represents the enterprises's performance in each of the weeks during the season.

Additionally, weighting factors of a given evaluator may be carried forward from week to week or from season to season, resulting in increased accuracy with time.

In certain applications, the weighting factors of the evaluators may be periodically reset.

Since the invention is described in the context of crowd-sourced evaluations of enterprises, the question arises regarding the scope of the enterprises to which a determined weight will be applied. For example, if a given evaluator achieves a weight of X when evaluating restaurants, will that same weight be applied to her evaluations of hotels. Recognize, however, that the hotel-applied weight will presumably change over multiple iterations as her evaluation is compared with the evaluations of others.

In one embodiment of the invention a weight is assigned to an evaluator for restaurant evaluations and a separate weight for hotel evaluations. In another embodiment the same weight can be applied to both restaurant and hotel evaluations since they both offer services to the public.

In yet another embodiment a first group of evaluators is selected to evaluate a specific service, e.g., restaurant services, and a second group is selected to evaluate hotel services. In a more granular application of the invention, certain evaluators are selected to evaluate one sub-category of restaurant services, e.g., food quality, cleanliness, speed of service.

The results developed by the techniques of the present invention can be particularly advantageous when presented in the form of a data structure, such as a spread sheet. Fields of the data structure may include: an identifier field (e.g. name of the evaluee), an industry field (e.g. hotels, restaurants, profession services, etc. of the evaluee), an updated weighted-average rating field, and a field indicating the number of evaluators used to derive the updated weighted-average rating. Such a data structure is novel since this type of data has not previously been stored in such a format. Data stored in the format can be easily browsed by anyone interested in patronizing the evaluee, such as a consumer (e.g., traveler). Further, this technique for evaluating enterprises is more efficient and less expensive than employing critics to travel the country in search of enterprises.

The updated weighted-average rating (i.e., a final updated weighted-average rating) for an enterprise or a group of enterprises can be supplied to interested consumers though a subscription service to which interested consumers subscribe. The evaluations provided may be limited to a specific class of enterprises (e.g., hotels or restaurants) and/or limited to a specific geographic region (i.e., the region in which the subscriber lives).

This Detailed Description is therefore not to be taken or considered in a limiting sense, and the appended claims, as well as the full range of equivalent embodiments to which such claims are entitled define the scope of various embodiments. This disclosure is intended to cover any and all adaptations, variations, or various embodiments. Combinations of presented embodiments, and other embodiments not specifically described herein by the descriptions, examples, or appended claims, may be apparent to those of skill in the art upon reviewing the above description and are considered part of the current invention.

What is claimed is:

1. A method for determining a final rating of an enterprise, the method comprising:
(a) determining an initial quantitative measure for each evaluator;
(b) applying a respective initial quantitative measure to a rating provided by each evaluator and generating an initial weighted rating for each evaluator;
(c) combining the initial weighted rating of all evaluators to determine an initial weighted-average rating of the enterprise;
(d) determining an updated quantitative measure for each evaluator representative of a differential between the initial weighted rating for each evaluator and the initial weighted-average rating of the enterprise;
(e) for each evaluator, applying the respective updated quantitative measure to the rating to generate an updated weighted rating;
(f) combining the updated weighted rating of all evaluators to generate an updated weighted-average rating of the enterprise;
(g) determining an updated quantitative measure for each evaluator representative of a differential between the updated weighted rating of an evaluator and the updated weighted-average rating of the enterprise;
(h) repeating steps (e) through (g) until the differential of step (g) is less than a predetermined value or until steps (e) through (g) have been repeated a predetermined number of iterations;
(i) when the differential of step (g) is less than the predetermined value or the steps (e) through (g) have been repeated the predetermined number of iterations, combining a most recent updated weighted rating of all evaluators to generate the final rating of the enterprise; and
(j) operating a device according to the final rating of the enterprise or reporting the final rating of the enterprise.

2. Wherein the enterprise is one enterprise from among a plurality of enterprises, and wherein the method of claim 1 is executed to determine the final rating for each enterprise from among the plurality of enterprises, the method further comprising ordering the plurality of enterprises based on the final rating of each enterprise.

3. The method of claim 1 wherein the final rating is related to a product or service available from the enterprise or a consumer satisfaction-related attribute of the enterprise.

4. The method of claim 1 wherein the quantitative measure comprises a weighting factor.

5. The method of claim 1 wherein the initial quantitative measure is identical for each evaluator.

6. The method of claim 1 wherein steps (e) through (g) are repeated a number times between 1 and 100.

7. The method of claim 1 wherein the ratings of the enterprise that are provided by each evaluator within a predetermined time interval are used in the step (b).

8. The method of claim 1 wherein the enterprise comprises a provider of goods or services.

9. The method of claim 1 wherein each enterprise is evaluated by a predetermined number of evaluators.

10. The method of claim 1 wherein one or more of the evaluators comprise a home-area evaluator and each enterprise comprises a home-area enterprise or an out-of-town area enterprise, the method further comprising assigning a home-area evaluator to one or more out-of-town area enterprises.

11. The method of claim 1 wherein at least one evaluator comprises a skilled evaluator having evaluation skills related to a specific type of enterprise or related to a specific performance-related attribute of one or more enterprises, the step (b) further comprising applying an initial quantitative measure to the rating provided by the skilled evaluator for a specific type of enterprise, or to the rating related to a specific performance-related attribute of one of more enterprises.

12. The method of claim 1 wherein an evaluator is assigned to an enterprise for providing the rating based on attributes of the evaluator and attributes of the enterprise.

13. The method of claim 1 step (c) further comprising dividing a first sum by a second sum to determine the initial weighted-average rating, the first sum comprising a sum of the weighted ratings of all evaluators, and the second sum comprising a sum of the quantitative measures of all evaluators.

14. The method of claim 1 executed on a computer, a computer server, a plurality of networked, central, or cloud-based computers, a mobile device, a cell phone, a smart phone, a tablet device, a laptop device, and a wearable electronic device, as controlled by a computer-readable program.

15. The method of claim 1 wherein the final rating comprises a value selected from a rating scale, the rating scale comprising one of a linear rating scale, a logarithmic rating scale, a power-law rating scale, an exponential rating scale, or any combination thereof. The method of claim 1 wherein each updated quantitative measure comprises a weighting factor, wherein the weighting factor is determined by using the differential to calculate a weighting factor as mapped to a predetermined rating scale.

17. The method of claim 16 wherein the predetermined rating scale comprises a logarithmic scale, a linear scale or a combination of logarithmic and linear scales.

18. The method of claim 1 wherein each one of the plurality of evaluators provides the rating of the enterprise using a computing device having a data entry component and a screen display for viewing entered data.

19. The method of claim 1 the device comprising a display and the step of operating further comprising presenting information on the display related to the final rating of the enterprise.

21. The method of claim 1 the device having a communications capability and the step of operating further comprising communicating information related to the final rating of the enterprise.

22. The method of claim 1 wherein the final rating comprises is based on one or more attributes of the enterprise or an overall evaluation of the enterprise.

23. A method for programmatically determining a final rating of an enterprise, the method comprising:
under control of a hardware processor:
(a) outputting a user interface comprising a first interface element and configured to provide functionality for each one of a plurality of evaluators to provide a rating of the enterprise, the rating based on the service or goods provided by the enterprise according to one or more desired attributes of the enterprise;
(b) storing the rating provided by each one of the plurality of evaluators in a memory;
(c) determining an initial quantitative measure for each evaluator;
(d) programmatically applying a respective initial quantitative measure to the rating provided by each evaluator to generate an initial weighted rating for each evaluator;
(e) programmatically combining the initial weighted rating of all evaluators to determine an initial weighted-average rating of the enterprise;
(f) programmatically determining an updated quantitative measure for each evaluator representative of a differential between the initial weighted rating of each evaluator and the initial weighted-average rating of the enterprise;
(g) for each evaluator, programmatically applying a respective updated quantitative measure to the rating to generate an updated weighted rating;
(h) programmatically combining the updated weighted rating of all evaluators to generate an updated weighted-average rating of the enterprise;
(i) programmatically determining an updated quantitative measure for each evaluator representative of a differential between the updated weighted rating of an evaluator and the updated weighted-average rating of the enterprise;
(j) repeating steps (g) through (i) until the differential of step (i) is less than a predetermined value, or until steps (g) through (i) have been repeated a predetermined number of iterations;
(k) when the differential of the step (i) is less than the predetermined value or the steps (g) through (i) have been repeated the predetermined number of iterations, combining a most recent updated weighted rating of all evaluators to generate the final rating of the enterprise; and
(I) forming a data structure for each enterprise including a first field indicating an identifier for the enterprise and a second field indicating the final rating of the enterprise.

24. Wherein the enterprise is one enterprise from a plurality of enterprises, and wherein the method of claim 23 is executed to determine a final rating of each enterprise of the plurality of enterprises, the method further comprising ordering the plurality of enterprises based on the final rating of each enterprise.

25. The method of claim 23 wherein the final rating is related to a consumed good or service-related attribute of the enterprise.

26. The method of claim 23 wherein the quantitative measure comprises a weighting factor.

27. The method of claim 23 step (e) further comprising dividing a first sum by a second sum to determine the initial weighted-average rating, the first sum comprising a sum of the weighted ratings of all evaluators, and the second sum comprising a sum of the quantitative measures of all evaluators.

28. The method of claim 23 wherein the final rating comprises a value selected from a rating scale, the rating comprises one of a linear rating scale, a logarithmic rating scale, a power-law rating scale, an exponential rating scale or any combination thereof.

29. The method of claim 23 wherein the step of programmatically determining the updated quantitative measure comprises calculating a difference between an updated weighted rating of each evaluator and the updated weighted-average rating of the enterprise, wherein each quantitative measure comprises a weighting factor, wherein the weighting factor is determined by using the difference to calculate a weighting factor as mapped to a predetermined rating scale, further comprising a logarithmic scale, a linear scale or a combination of logarithmic and linear scales.

30. A non-transitory machine-readable storage medium comprising instructions that, when executed by one or more processors of a machine, cause the machine to perform a method for determining a final rating of an enterprise based on a rating supplied by each one of a plurality of evaluators, the method comprising:
(a) determining an initial quantitative weight for each evaluator;
(b) applying a respective initial quantitative weight to a rating provided by each evaluator and generating, for each evaluator, an initial weighted rating of the enterprise;
(c) combining the initial weighted rating of each evaluator to determine an initial weighted-average rating of the enterprise;
(d) determining an updated quantitative weight for each evaluator representative of a differential between the initial rating by an evaluator and the initial weighted-average rating of the enterprise;
(e) for each evaluator, applying a respective updated quantitative weight to each rating to generate an updated weighted rating;
(f) combining the updated weighted rating of all evaluators to generate an updated weighted-average rating of the enterprise;
(g) determining an updated quantitative measure for each evaluator representative of a differential between the rating of an evaluator and the updated weighted-average rating of the enterprise;
(h) repeating steps (e) through (g) until the differential of step (g) is less than a predetermined value or until steps (e) through (g) have been repeated a predetermined number of iterations; and
(i) when the differential of step (g) is less than the predetermined value or the steps (e) through (g) have been repeated the predetermined number of iterations, combining a most recent updated weighted rating of all evaluators to generate the final rating of the enterprise.

31. Wherein the enterprise is one enterprise from a plurality of enterprises, and wherein the method of claim 30 is executed to determine a final rating of each enterprise of the plurality of enterprises, the method further comprising ordering the plurality of enterprises based on the final rating of each enterprise.

32. The method of claim 30 wherein the overall rating is related to a consumed good or service-related attribute of the enterprise.

33. The method of claim 30 step (c) further comprising dividing a first sum by a second sum to determine the initial weighted-average rating, the first sum comprising a sum of the weighted ratings of all evaluators, and the second sum comprising a sum of the quantitative weights of all evaluators.

34. The method of claim 30 wherein the rating comprises a value selected from a rating scale, the rating comprises one of a linear rating scale, a logarithmic rating scale, a power-law rating scale, an exponential rating scale or any combination thereof.

35. The method of claim 30 wherein the step of determining the updated quantitative measure comprises calculating a difference between a rating of each evaluator and a weighted-average rating, wherein the quantitative measure comprises a weighting factor, wherein the weighting factor is determined using the difference to calculate a weighting factor as mapped to a predetermined rating scale, further comprising a logarithmic scale, a linear scale or a combination of logarithmic and linear scales.

36. An apparatus comprising:
a display;
at least one processor; and
at least one memory including one or more sequences of instructions, the at least one memory and the one or more sequences of instructions operative with the at least one processor configured to cause the apparatus to perform at least the following:
receive identifying criteria for each one of a plurality of evaluators;
receive identifying criteria for an enterprise;
receive a rating of the enterprise as supplied by each evaluator;
receive an initial quantitative measure for each evaluator;
for each evaluator, determine an initial weighted rating of the enterprise by applying a respective initial quantitative measure for each evaluator to the rating of the enterprise supplied by each evaluator;
combine the initial weighted rating of the enterprise supplied by all evaluators to determine an initial weighted-average rating of the enterprise;
determine an updated quantitative measure for each evaluator representative of a differential between an initial weighted rating by an evaluator, and an initial weighted-average rating of the enterprise;
for each evaluator apply the respective updated quantitative measure to each rating to generate an updated weighted rating for each evaluator; and
combine the updated weighted rating of all evaluators to determine an updated weighted-average rating.
